(19) United States
(12) Patent Application Publication
(10) Pub. No.: US 2005/0243068 A1
(43) Pub. Date: Nov. 3, 2005

(54) Touch sensing

(75) Inventors: Mark Thomas Johnson, Eindhoven (NL); Alexander Victor Henzen, Heerlen (NL); Hugo Johan Cornelissen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/526,862

(22) PCT Filed: Sep. 1, 2003
(86) PCT No.: PCT/IB03/03850

§ 371 Date: Mar. 4, 2005

(30) Foreign Application Priority Data
Sep. 6, 2002 (EP) 02078677.8

(51) Int. Cl. G09G 5/00

(52) U.S. Cl. 345/173

(57) ABSTRACT

A touch sensitive matrix display senses touch input during a sense period (TS) in a separate sense area (A1) which is selected to be non-overlapping with a display area (A2) in which information is displayed dependent on the touch position which is sensed in the sense area (A1). During the sense period (TS), the sense area (A1) is not addressed. The non-address period of time (TR) occurring between two successive sense area addressing periods (TA2) of the sense area (A1) lasts at least as long as, but preferably substantially longer than, the display area address period (TA1,i) required to address the complete display area (A2). The data displayed in the sense area (A1) is refreshed by addressing the sense area (A1) during the sense area address periods (TA2) in-between the sense periods (TS). The data displayed in the sense area (A1) will not be disturbed by the sensing and will be present between two successive sense area addressing periods (TA2, TA2′) because the pixels 10 of the matrix display have an optical state which, when not addressed, is maintained longer than the non-address period (TR).

The invention relates to a touch sensitive matrix display, a display apparatus comprising such a touch sensitive matrix display, and a method of touch sensing.

EP-B-0416176 discloses a non-mechanical and a non-emissive matrix display which supplies signals to the row and column electrodes of the display to display information, and which senses with the row and column electrodes the position of an input pen which is electrically coupled to the display. Separate input pen sense electronics can be provided for each individual area of the device on which there is pen input. Likewise, separate display regions can be provided with their own dedicated display control subsystems. All the sense regions have to be addressed with a high repetition frequency to display information in the sense regions.

It is an object of the invention to provide a touch sensitive matrix display which consumes less power.

A first aspect of the invention provides a touch sensitive matrix display as claimed in claim 1. A second aspect of the invention provides a display apparatus as claimed in claim 8. A third aspect of the invention provides a method of touch sensing as claimed in claim 9. Advantageous embodiments are defined in the dependent claims.

A touch sensitive matrix display senses touch input during a sense period in a separate sense area which is selected to be non-overlapping with a display area in which information is displayed dependent on the touch position which is sensed in the sense area. During the sense period, the sense area is not addressed. The non-address period occurring between two successive sense area addressing periods of the sense area lasts at least as long as, but preferably substantially longer than, the display area address period required to address the complete display area. The data displayed in the sense area is refreshed by addressing the sense area during the sense area address periods in-between the sense periods. The data displayed in the sense area will not be disturbed by the sensing and will be present between two successive sense area addressing periods because the pixels 10 of the matrix display have an optical state which, when not addressed, is maintained longer than the non-address period.

Such an optical state which is maintained substantially longer than the non-address period is for example available in bistable displays such as an electrophoretic display.

During a substantially long time (the non-address period of the sense area), the drive scheme in accordance with the invention needs to address only the display part of the display where the changing information has to be displayed in response to the sensed input provided in the sense area. Consequently the power dissipation will be lower than when the total display area has to be addressed continuously.

The partial activation of the matrix display may be implemented in many ways, for example, the addressing circuit may be controlled to use only a part of the drivers to drive only a subset of the select electrodes and the data electrodes, or the select electrodes and the data electrodes are separated into groups driven by different drivers, or additional data electrodes are provided that extend over part of the display area only.

It is known from PDA's using an LCD, that input is sensed in a first area while information dependent on the input is displayed in a second area, for example, a keyboard is displayed on a lower part of the display, and the text inputted on the keyboard is displayed in an upper part of the display. However, to display the keyboard, this lower part which is used for sensing input is also addressed during the sensing. More generally, in a totally different implementation, a transparent separate touch screen is present covering (part of) the display.

In an embodiment as defined in claim 2, the display is configured such that the sensing circuit is coupled to a subset of the select electrodes which subset is associated with the sense area only. The sense circuit need not be coupled to the select electrodes of the display area as no sensing is required in the display area.

In an embodiment as defined in claim 3, the select and data electrodes are divided in two groups, one group is associated with the display area and the other group is associated with the sense area. The group associated with the display area is driven to only address the display area. As the sensing is not required in the display area, the addressing may be performed continuously to reach a high refresh rate and to minimize movement artifacts. The other group drives the sense area to intermittently interrupt the sensing for touch input to enable to refresh the information displayed. Preferably, the refreshing is performed once in several addressing periods required to address the complete display area to minimize the power consumption in the sense area. Extremely low power consumption is very important in portable applications.

The separate groups enable to concurrently address the display area and to sense in the sense area without the need for extra electrodes.

In an embodiment as defined in claim 4, the data electrodes are divided in a first group which is associated with the display area, and a second group which is associated with the sense area. A switch is arranged between each data electrode of the first group and the corresponding data electrode of the second group. The switches are open during the sensing period wherein the touch events are sensed in the sense area. This enables to sense in the sense area while the display area is addressed without the need for extra electrodes. The switches are closed when the sense area is addressed to refresh the display data of the sense area. The same data drivers can be used for addressing both the display and the sense area.

In an embodiment as defined in claim 5, the matrix display is configured to be able to address all the pixels. Special sense electrodes are implemented for the sense area only. These extra sense electrodes enable to determine the position coordinate along the direction of the select electrodes. This has the advantage that the display area can be continuously addressed while still concurrently, the sensing in the sense area is possible via the sense electrodes.

In prior art touch sensitive matrix displays, usually, the data is written into the pixels by selecting a line of pixels associated with a selected one of select electrodes, and writing data to the selected line of pixels. During the addressing period (also referred to as frame period), the lines are selected one by one and for each line the data is written. As during the addressing period, continuously data is written to the pixels, the sensing of the touch position along the direction of the lines cannot use the data electrodes. Consequently, a complicated driving scheme is required to sense the touch position in-between the writing of the data.

In the embodiment of the invention as defined in claims 3, 4 or 5, the display area may be addressed in the usual manner which provides a high refresh rate of the data displayed while the sensing in the sense area is not disturbed as separate electrodes are used.

In an embodiment as defined in claim 6, at least two successive ones of the display area address periods in which all the pixels of the display area are addressed are not immediately adjacent in time. A time period is available between these two display area address periods in which the sensing in the sense area is performed. In this manner, the sensing in the sense area is not disturbed by supplying data to the pixels of the address electrodes which are in common for both the sense and the display area. It is not a problem that the data in the sense area is not refreshed at a high rate as this is, in a particular application such as a keyboard or a calculator layout, fixed information, for example, a set of symbols, letters, and/or numbers. This allows a relatively long sense period, which may even be substantially longer than the period required to address the sense area or the display area or both. The sensing is inactive during the relatively short period in time the data is supplied to the sense area.

Consequently, during the sense period, the sensing is not disturbed by a continuously occurring addressing. The addressing of the display area is never disturbed by the sensing as the sensing only occurs in the sense area. This simplifies the operation of the display.

During the sense period, it is possible to use the existing data electrodes associated with the first area to sense one of the coordinates of the touch position because the data is written to the display area during the addressing period only which occurs in-between successive sense periods.

These and other aspects of the invention are apparent from and will be elucidated with reference to the embodiments described hereinafter.

In the drawings:

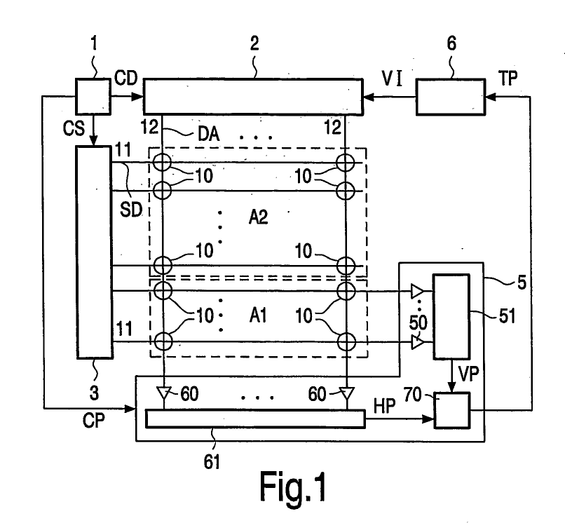

FIG. 1 shows a block diagram of a display apparatus comprising a touch sensitive matrix display,

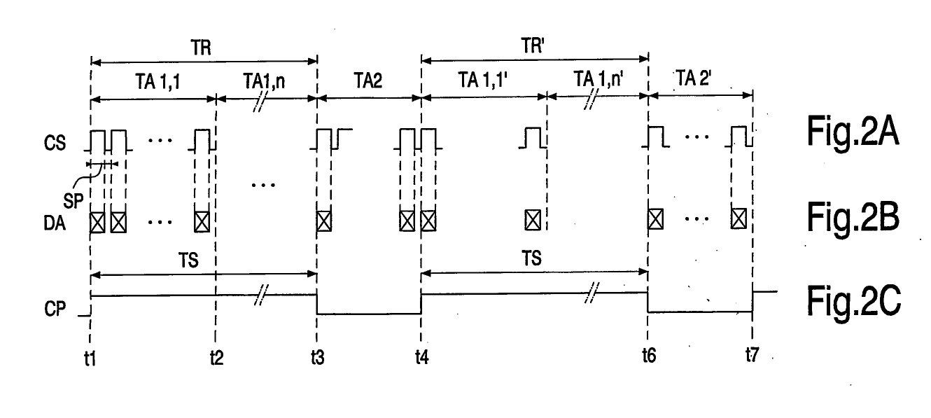

FIGS. 2 show signals elucidating the operation of the display apparatus of FIG. 1,

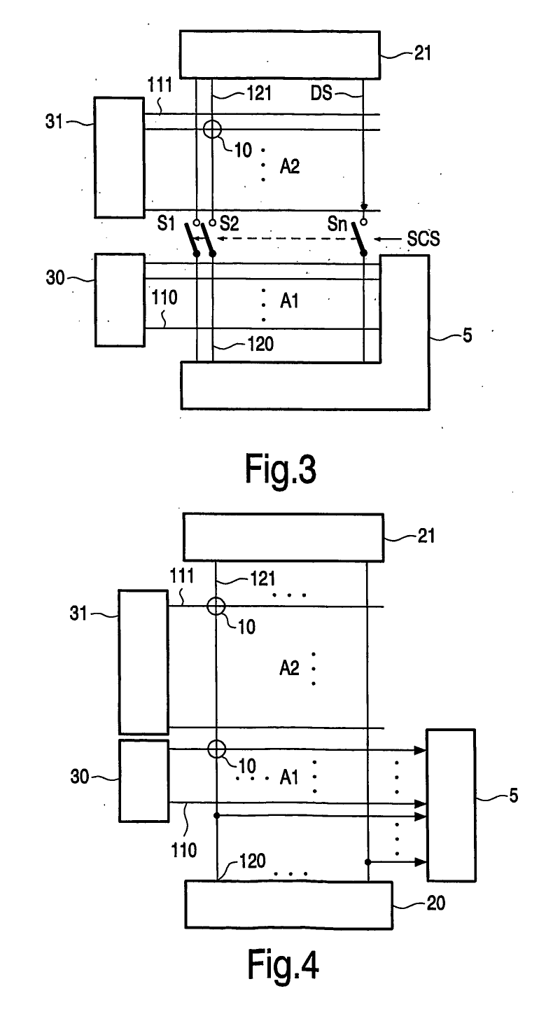

FIG. 3 shows an embodiment of the matrix display in accordance with the invention,

FIG. 4 shows another embodiment of the matrix display in accordance with the invention,

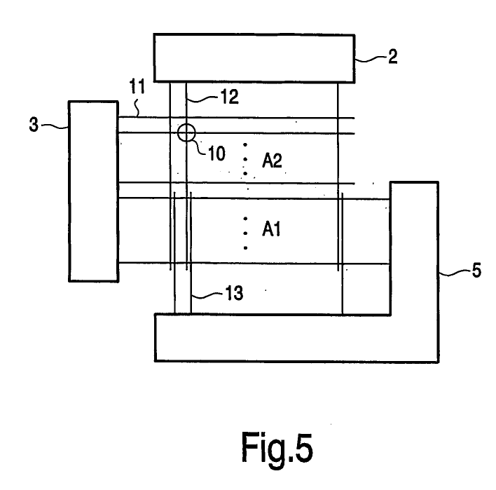

FIG. 5 shows yet another embodiment of the matrix display in accordance with the invention, and

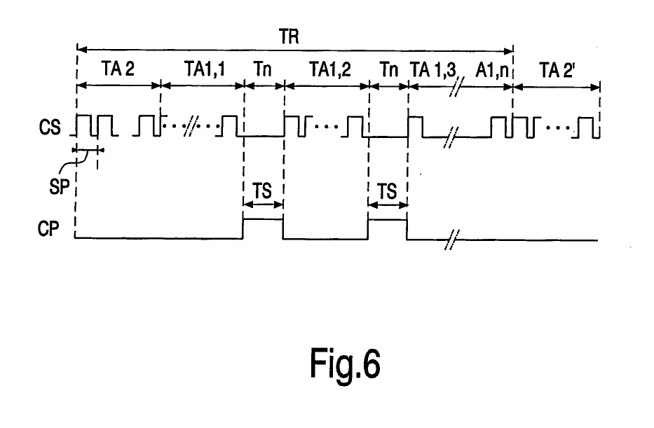

FIG. 6 shows signals for elucidating an embodiment in accordance with the invention.

The same references in different Figs. refer to the same signals or to the same elements performing the same function. References with one or more capital letters followed by an indices i, refer to all references starting with the same capital letter(s) followed by a number.

FIG. 1 shows a block diagram of a display apparatus comprising a touch sensitive matrix display. The touch sensitive matrix display has a first area A1, also referred to as the sense area, wherein data is displayed to indicate touch positions and wherein the positions of touch events are detected, and a second area A2, also referred to as display area, wherein data is displayed in response to the touch events detected.

The touch sensitive matrix display comprises crossing select electrodes 11 and data electrodes 12. The pixels 10 are associated with intersections of the select electrodes 11 and the data electrodes 12. The addressing circuit comprises a data driver 2 and a select driver 3. The data driver receives input data VI and supplies data signals DA to the data electrodes 12. The select driver supplies select signals SD to the select electrodes 11.

A sense circuit 5 comprises a plurality of measuring circuits 50, each one with an input coupled to the select electrodes 11 which are associated with the sense area A1, a plurality of measuring circuits 60, each one with an input coupled to the data electrodes 12. A detection circuit 51 is coupled to outputs of the measuring circuits 50 to supply a touch position VP along the direction of the data electrodes 12. A detection circuit 61 is coupled to outputs of the measuring circuits 60 to supply a touch position HP along the direction of the select electrodes 11. A position determining circuit 70 is coupled to the detection circuits 51 and 61 to receive the position of a touch event VP, HP in the direction of the data electrodes 12 and the select electrodes 11, respectively, and to supply the touch position TP. The measuring circuits 50 and 60, for example, are charge sensitive amplifiers.

A control circuit 1 supplies control signals CD, CS and CP to the data driver 2, the select driver 3 and the sense circuit 5, respectively. A signal processing circuit 6 receives the touch position TP and supplies the input data VI to the data driver 2. The input data depends on the touch position TP detected.

FIGS. 2 show signals elucidating the operation of the display apparatus of FIG. 1. Periods in time without an apostrophe refer to a particular operation cycle of the display, periods in time indicated with an apostrophe refer to an operation cycle of the display succeeding the particular operation cycle.

FIG. 2A shows the control signal CS which controls the select driver 3 to select the select electrodes 11 one by one during the addressing periods TA1,1 to TA1,n and TA2. The select time per select electrode 11 is the select period SP.

In each of the (display area) addressing periods TA1,1 to TA1,n all the pixels 10 of the display area A2 are selected to receive data DA. If the pixels 10 are selected line by line, the number of select periods per addressing period TA1,1 to TA1,n is equal to the number of select lines 11 which are associated with the display area A2. The first addressing period TA1,1 last from the instant t1 to the instant t2. All the addressing periods TA1,1 to TA1,n occur during the addressing period TR of the display area A2. This addressing period TR lasts from the instant t1 to the instant t3. A next addressing period TR′ of the display area A2 lasts from the instant t4 to t6.

During the (sense area) addressing period TA2 which lasts from the instant t3 to the instant t4, the sense area A1 is addressed to receive the data to be displayed in this area. A next addressing period TA2′ of the sense area lasts from the instant t6 to t7.

FIG. 2B shows the data signals DA supplied to the selected select electrode 11 during each select period SP via the data electrodes 12. Data signals DA have to be supplied via each data electrode 12, during each select period SP. Thus for each select period SP, a block of data signals DA is required as indicated by the crossed blocks. During the addressing periods TA1,1 to TA1,n the data is supplied to the select lines 11 associated with the display area A2, during the addressing period TA2, the data DA is supplied to the select lines 11 associated with the sense area A1.

FIG. 2C shows the control signal CP supplied to the sense circuit 5. The high level of the control signal CP indicates the sense periods TS during which the sense circuit 5 senses for a touch event to determine the touch position. The sense periods TS are intermittently interrupted during the addressing period TA2 in which data is supplied to the sense area A1.

The touch events are detected by the sense circuit 5 which comprises the measurement circuits 50 and 60, the touch position determining circuits 51 and 61, and the combiner 70. Touch events which occur during the addressing period TA2 are not sensed as the sense circuit 5 is inactive during the addressing period TA2. It is not essential that the sense periods TS last the whole display area address period TR in which the display area A2 is addressed several times.

In an embodiment, the touch event is determined from a changing property of an element of the pixel 10 or an element provided near to the pixel 10. For example, the changing capacitance of the pixel 10 when a pressure is applied may be measured by the measurement circuits 50 and 60 which are charge sensitive amplifiers. Alternatively, a pressure sensitive element may be arranged near the pixel 10, and the measurement circuits 50 and 60 determine the impedance change of the pressure sensitive element, for example by detecting a current flowing through the pressure sensitive element at a fixed voltage across it. Many alternatives ways are possible to detect the touch event. For example, it is also possible to associate a light sensitive element with each one of the pixels.

The touch position determining circuit 51 determines the position of the touch event in the direction of the data electrodes 12 from the output signals of the measurement circuits which indicate where in the direction of the data electrodes a touch is detected. Usually, the data electrodes 12 extend in the vertical direction and the touch determining circuit 51 provides the vertical position VP of a touch event as a number(s) indicating the select electrode(s) 11 corresponding to the vertical position the touch event is detected. The touch position determining circuit 61 determines the position of the touch event in the direction of the select electrodes 11. Usually, the select electrodes 11 extend in the horizontal direction and the touch determining circuit 61 provides the horizontal position HP of a touch event. The optional combiner 70 combines the horizontal and the vertical positions into a single data word. The circuits 51, 61 and 70 may be dedicated circuits or a microprocessor.

The addressing of the display panel as elucidated with respect to the signals shown in FIG. 2 is an example only. It is also possible to select the pixels 10 in another scheme, for example, one by one.

FIG. 3 shows an embodiment of the matrix display in accordance with the invention. The matrix display panel is divided in two areas. In the sense area A1 a touch input is sensed and in the display area A2 information is displayed dependent on the touch input sensed. The information displayed in the sense area A1 is refreshed at a low rate by addressing the sense area A1 intermittently.

The display area select driver 31 selects the select electrodes 111 of display area A2 one by one, and the data driver 21 supplies the data signals DS to the data electrodes 121 of the display area A2. The sense area select driver 30 is coupled to the select electrodes 110 of sense area A1, and the sensing circuit 5 is coupled to the select electrodes 110 and to the data electrodes 120 of the sense area A1 to sense touch inputs.

Switches S1 to Sn are arranged between corresponding data electrodes 120 and 121 of the display area A2 and the sense area A1, respectively. The switches S1 to Sn are controlled by a control signal SCS.

When the control signal SCS controls the switches S1 to Sn to be open, the display area A2 and the sense area A1 are independently operated. The display area A2 is addressed by the display area select driver 31 and the data driver 21 in a known manner. The sense circuit 5 senses the touch events and their position. The sense area select driver is inoperative in the sensing mode of the sense area A1. The independent operation of the address area A2 and the sense area A1 enables to continuously address the display area A2 to display the information with a high refresh rate, while the sensing can be performed concurrently in the sense area A1 without the need for extra electrodes.

When the control signal SCS controls the switches S1 to Sn to be closed, both the display area A2 and the sense area A1 are driven by the same data signals DS generated by the data driver 21. The sense select driver 30 is operative and together with the display select driver 31 selects the select electrodes 111 and 110 one by one, while the data driver 21 supplies the data signals DS to the data electrodes 121 and 120. Now, both the display area A2 and the sense area A1 are addressed to receive data. The sense circuit 5 is inoperative during this period in which the complete display is addressed in the usual way.

It is possible to divide the matrix display panel in more than two areas.

It is possible to omit the switches S1 to Sn. Now the display comprises two separately driven areas as elucidated with respect to FIG. 4.

FIG. 4 shows another embodiment of the matrix display in accordance with the invention. Again the display is divided into the display area A2 and the sense area A1. The display area select driver 31 and the display area data driver 21 drive the select electrodes 111 and the data electrodes 121 of the display area, respectively. The sense area select driver 30 and the sense area data driver 20 drive the select electrodes 110 and the data electrodes 120 of the sense area, respectively. The sense circuit 5 is coupled to both the select electrodes 110 and the data electrodes 120.

Now, the addressing of the display area A2 is completely independent on the operation of the sense area A1, and it is possible to continuously address the pixels 10 of the display area. During the majority of the time, the sense area A1 is used as a sense area to sense touch events, and occasionally, the sense area A1 is addressed to refresh the information displayed in the sense area A1. During the sensing phase, the sense circuit 5 detects via the existing select electrodes 110 and the existing data electrodes 120 the position of a sense event. During the addressing phase, the sensing is inactive, and the sense area is addressed by the sense area select driver 30 and the sense area data driver 20 to refresh the data in the pixels of the sense area A1.

FIG. 5 shows another embodiment of the matrix display in accordance with the invention. The select driver 3 drives both the select electrodes 11 of the display area A2 and the sense area A1. The data driver 2 drives the data electrodes 12 which extend both in the display area A2 and in the sense area A1. The sense circuit 5 is coupled to the select electrodes associated with the sense area A1 and to separate select electrodes 13 which extend in the direction of the data electrodes in the sense area A1 and not in the display area A2.

When, during the majority of the time, the sense area is used to sense touch events, the select circuit 3 does not activate the select electrodes 11 which are associated with the sense area A1. Only the select electrodes 11 associated with the display area are activated, usually one by one, while the data driver 2 supplies data signals to the data electrodes 12. The sense circuit 5 is able to use the unused select electrodes 11 and the extra sense electrodes 13 to sense the position of a touch event in the sense area A1. The sense circuit can not use the data electrodes 12 because these are continuously in use for addressing the display area A2.

When during a relatively short period in time, the sense area should be addressed, the select driver 3 will also activate the select electrodes 11 associated with the sense area A1, usually one by one, while the data driver 2 supplies data signals to the data electrodes 12. The sense circuit 5 is unable to sense for touch events during this relative short time period.

Thus, this embodiment of the matrix display is able to address the complete display in the usual way, but will for the majority of the time only address the display area A2 of the display. The sensing in the sense area A1 can be performed concurrently to the addressing of the display area A2 due to the separate sense electrodes 13. No special provisions in the driving of the matrix display are required for the short time the sense area A1 has to be addressed.

FIG. 6 shows signals for elucidating an embodiment in accordance with the invention. FIG. 6 shows the control signal CS which controls the select driver 3 to select the select electrodes 11 one by one during the addressing periods TA1,1 to TA1,n and TA2. The select time per select electrode 11 is the select period SP.

In each of the (display area) addressing periods TA1,1 to TA1,n all the pixels 10 of the display area A2 are selected to receive data DA. If the pixels 10 are selected line by line, the number of select periods per addressing period TA1,1 to TA1,n is equal to the number of select lines 11 which are associated with the display area A2.

During the (sense area) addressing period TA2, the sense area A1 is addressed to receive the data to be displayed in this area

FIG. 6 shows the control signal CP supplied to the sense circuit 5. The high level of the control signal CP indicates the sense periods TS during which the sense circuit 5 senses for a touch event to determine the touch position. The sense periods TS are intermittently interrupted during both the addressing periods TA1,1 to TA1,n and the addressing period TA2 in which data is supplied to the display area A2 and the sense area A1, respectively. Further, at least two of the addressing periods TA1,1 to TA1,n of the display area A2 are separated in time to create a non-addressing time period during which the addressing of complete display areas is interrupted. The sensing of the touch events in the sense area A1 is performed during these non-addressing periods in time. Although this has the drawback that the sensing of the touch events occurs during relatively short periods in time, it is possible to use the existing data electrodes 12 for sensing as no data is supplied to the data electrodes 12 during the non-addressing periods.

Many alternative schemes are possible, a non-addressing time may be present after every addressing period TA1,i, or only after several addressing periods TA1,i.

It should be noted that the above-mentioned embodiments illustrate rather than limit the invention, and that those skilled in the art will be able to design many alternative embodiments without departing from the scope of the appended claims.

The invention is interesting for application as a low power combined input and output device, such as, as for example, a typewriter, a calculator, a menu reader. The invention is particular interesting for bi-stable matrix displays such as for example electrophoretic matrix displays.

The touch sensitive regions are reconfigurable. For example, the size of the touch pad can be tailored to the size of the keyboard or menu feature by defining the number of pixels which will be sensed in parallel. In the remainder of the display, the result of the touch input will be made visible.

In the claims, any reference signs placed between parentheses shall not be construed as limiting the claim. The word “comprising” does not exclude the presence of elements or steps other than those listed in a claim. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A touch sensitive matrix display comprising
a matrix of pixels,
a sensing circuit for sensing a touch position with a first subset of the pixels forming a first area (A1) of said matrix display,
an addressing circuit for addressing a second subset of the pixels forming a second area (A2) of said matrix display being non-overlapping with the first area (A1) to display information dependent on the touch position, and
a controlling circuit for controlling the addressing circuit to address the first area (A1) intermittently during sense area address periods (TA2) to supply display information to the first area (A1) in-between the sense periods (TS) only, a non-address period of time (TR) between two successive sense area address periods (TA2) being at least as long as a display area address period (TA1,i) wherein all the pixels of the second area (A2) are addressed, the pixels having an optical state which, when not addressed, is maintained longer than the non-address period of time (TR).

2. A touch sensitive matrix display as claimed in claim 1, characterized in that said matrix display comprises select electrodes and data electrodes, the pixels being associated with intersections of the select electrodes and the data electrodes, the sensing circuit being coupled to a subset of the select electrodes only, for only sensing in the first area (A1).

3. A touch sensitive matrix display as claimed in claim 2, characterized in that
the select electrodes comprise a first set of select electrodes and a second set of select electrodes, the data electrodes comprise a first set of data electrodes and a second set of data electrodes, the first set of select electrodes and a first set of data electrodes being associated with the first area (A1), the second set of select electrodes and the second set of data electrodes being associated with the second area (A2), and in that
the addressing circuit comprises
a first select driver coupled to the first set of select electrodes, and a first data driver coupled to the first set of data electrodes for intermittently sensing touch input and supplying display information to the first area (A1), and
a second select driver coupled to the second set of select electrodes, and a second data driver coupled to the second set of the data electrodes for addressing the second area (A2).

4. A touch sensitive matrix display as claimed in claim 2, characterized in that
the data electrodes are divided in a first group (G1) which is associated with the display area (A2), and a second group (G2) which is associated with the sense area (A1), in that
said display further comprises switches (Si) being arranged between corresponding data electrodes of the first and the second group (G1, G2), and in that
the control circuit is adapted for closing the switches (Si) when the sense area (A1) is addressed, and for disconnecting the corresponding data electrodes of the first and the second group (G1, G2) during the sense periods (TS) wherein the touch events are sensed in the sense area (A1).

5. A touch sensitive matrix display as claimed in claim 2, characterized in that
said display further comprises sense electrodes arranged in parallel with the data electrodes and extending in the first area (A1) only,
the addressing circuit comprises a select driver coupled to the select electrodes, and a data driver coupled to the data electrodes for supplying display information to both the first area (A1) and the second area (A2), and
the sensing circuit is coupled to sense electrodes and at least a subset of the select electrodes being associated with the first area (A1).

6. A touch sensitive matrix display as claimed in claim 2, characterized in that
the control circuit is adapted for controlling the addressing circuit to address the second area (A2) during at least two successive address periods (TA1,i) being spaced apart by a sensing period (TS), and for controlling the sensing circuit to sense touch events during the sensing period (TS).

7. A touch sensitive matrix display as claimed in claim 1, characterized in that said matrix display is an electrophoretic display.

8. A display apparatus comprising
the touch sensitive matrix display as claimed in claim 1, and
a signal processor for supplying input data (VI) to the addressing circuit in dependence on the touch position sensed to generate at least part of an image to be displayed on the touch sensitive matrix display.

9. A method of touch sensing in a touch sensitive matrix display comprising a matrix of pixels, the method comprising
sensing a touch position with a first subset of the pixels forming a first area (A1) of said matrix display, wherein the pixels have an optical state which, when not addressed, is maintained longer than a sense period (TS) during which the sensing circuit senses the first area (A1),
addressing a second subset of the pixels forming a second area (A2) of said matrix display being non-overlapping with the first area (A1) to display information dependent on the touch position,
controlling the addressing circuit to address the first area (A1) intermittently to supply display information to the first area (A1) in-between the sense periods (TS) only.
